(19) United States
(12) Patent Application Publication
(10) Pub. No.: US 2003/0208641 A1
(43) Pub. Date: Nov. 6, 2003

(54) Software components as virtual processors

(76) Inventor: Darren L. Wesemann, North Salt Lake, UT (US)

Correspondence Address: R. Burns Israelsen, WORKMAN, NYDEGGER & SEELEY, 1000 Eagle Gate Tower, 60 East South Temple, Salt Lake City, UT, 84111, US

(21) Appl. No.: 09/829,673

(22) Filed: Apr. 10, 2001

Related U.S. Application Data
(63) Continuation-in-part of application No. 09/265,287, filed on Mar. 9, 1999, now Pat. No. 6,434,594.
(60) Provisional application No. 60/263,462, filed on Jan. 22, 2001.

(51) Int. Cl. G06F 9/00

(52) U.S. Cl. 709/332

(57) ABSTRACT

Methods, systems, and computer program products for dynamically accessing software components in an environment that may include a plurality of processing nodes. Each node includes one or more software objects, such as one or more software component objects (virtual processors), a controller object, a database object, a trace object, an agent object, etc. Requests for the functionality implemented by a particular software component are load balanced across the available instances. If no software components are available, a request may be submitted to a scheduler. A software component also may be reserved for future processing. Relationships between software components are defined by platform independent logic that is accessible through a database object and processed by a controller object. An agent object tracks which software components are available at the one or more nodes for which the agent is responsible.

### RELATED APPLICATIONS

This application is a continuation-in-part of U.S. application Ser. No. 09/265,287, entitled “VIRTUAL PROCESSING NETWORK ENABLER,” and filed on Mar. 9, 1999; this application also claims the benefit of U.S. Provisional Application No. 60/263,462, entitled “METHODS, SYSTEMS, AND COMPUTER PROGRAM PRODUCTS FOR DEVELOPING AND ACCESSING SOFTWARE COMPONENTS,” and filed on Jan. 22, 2001. Each of the foregoing applications is hereby incorporated by reference.

### BACKGROUND OF THE INVENTION

1. The Field of the Invention

The present invention relates to software components. More specifically, the present invention relates to methods, systems, and computer program products for dynamically accessing software components in an environment that may include a plurality of processing nodes, each node potentially including one or more software objects.

2. Background and Related Art

To remain competitive, businesses continually provide new products and services, resulting in changes to business operations and a nearly endless stream of problems to address. Over time, many businesses may evolve to become constantly shifting and dynamic aggregations of customized business processes. Although changing requirements complicate the operation of most businesses, evolving technologies can provide an even greater challenge. For example, technologies may fail to deliver what they promise, or they may change too rapidly, making a business problem more difficult to solve than initially anticipated. Moreover, the specific benefits of any particular technology to a given organization may be difficult to evaluate in relation to emerging products and services. Where businesses use technology to support their operations, therefore, the technology may need to be modified and enhanced rather frequently to meet changing business requirements. In the end, solving business problems with technology generally involves a confusing mixture of software, hardware, engineering, and hype. Some businesses simply become overwhelmed by the task of constantly choosing from an almost limitless array of available technologies. Therefore, flexible technology-based solutions that allow for incremental modifications with minimal adverse impacting on the overall system may provide a competitive advantage in today's business environment.

Component technology, such as COM, DCOM, OLE, CORBA, RPC, etc., is one attempt at providing a flexible technology for implementing business processes. With component technology, a large variety of software products may be implemented in a relatively short time by reusing development efforts in multiple products. Software components facilitate reuse by delivering independent pieces of functionality that provide access to their services through interfaces. A well-defined interface is an important characteristic of a component because, when plugging components together in creating a larger system, the interface defines how individual components fit together. Ideally, individual components can be adapted for multiple purposes without modification. There is, however, considerable confusion and divergence in the basic nomenclature, design constructs, and interfaces offered by competing component technologies.

The relationships among components involve complicated communication and synchronization code. However, a component should expose only its functionality, and should be independent from the existence of other components. Independence insulates components from each other so that changes in one component do not ripple across all components. Thus, in order to maximize reusability, a component should exclude attributes that make it depend upon other components. Relationships, such as dependencies and associations between components, should be part of the infrastructure.

In an effort to meet the demands imposed by rapidly changing business environments, component technologies and standards are enhanced constantly, with models, methods, and processes for component development and use being defined and ratified continuously by various standards bodies and consortia. Each component technology, specification, or product, generally offers some advantages relating to the specific needs of an enterprise, but a large amount of expensive and high-maintenance infrastructure code often must be written to use the particular technology.

While the advancement in component technology provides advantages in capability and functionality, foundational ties between business requirements and component technology may require changes to the underlying component infrastructure. Furthermore, developers combining technologies, in an attempt to use the best features of each, may need to create mechanisms whereby separate and incompatible infrastructure services communicate with one another. Without a common infrastructure, an interface alone is unlikely to yield widely reusable components. Moreover, components deployed in a distributed environment are responsible for managing various types of distributed failures, locations, and formats. In the absence of a distributed infrastructure, development cycles may be prolonged.

### SUMMARY OF THE INVENTION

The present invention addresses the foregoing problems by providing an infrastructure for dynamically accessing software components in an environment that may include a plurality of processing nodes. Each node includes one or more software objects, such as one or more software component objects, a controller object, a database object, a trace object, an agent object, etc. Each software component implements functionality that may be used to accomplish a particular goal or task. A software component may be thought of as a virtual processor for performing the functionality it implements. Where high demand exists for a particular function, multiple instances of a software component may be created, with requests being load balanced across the available instances.

Relationships between software components are defined by platform independent logic. A controller object receives the logic from a database object or from a controller object on another node, and executes the logic to determine process flow and branching. Requests for the functionality of a software object on a node may originate from a number of sources, including the executed logic, a remote node, a scheduler, as part of an initialization procedure, etc. Upon receiving a request for functionality, the controller determines if a local software component is available to satisfy the request or if another node should be contacted.

An agent object tracks the software components available at the one or more nodes for which the agent is responsible. The agent also tracks the state or status of software components in varying degrees of accuracy. For example, if the agent receives a request for functionality, the agent is able to make better routing decisions if the agent knows (i) where a particular software component is located, and (ii) if the particular software component is busy processing other requests. If no software components are available, the request is submitted to a scheduler; otherwise, the request is sent to a remote node with a software component that is able to satisfy or process the request.

For local requests, a suitable software component is identified and the controller reserves and sets blocking for the identified software component as appropriate. The controller updates the status information of the identified controller that is tracked by the node's agent. At this point, the controller calls the component with the request for processing. The component processes the request by running the corresponding function that implements the functionality being requested and notifies the agent so that status information may be updated. Other requests are processed in a similar fashion.

Individual software components may be completely independent and unaware of each other to minimize interdependencies that are best handled by the platform independent logic. To enhance load balancing, multiple requests for the same functionality by a single source may be processed by different software components. Although some overhead may be attributed to processing requests for functionality independent of prior requests, the benefits of load balancing may be more significant. Furthermore, a software component may be reserved for future processing as the circumstances may dictate.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered as limiting its scope, the invention will be described and explained with additional specificity and detail through the use of the accompanying drawings in which:

FIG. 1 illustrates an exemplary system that provides a suitable operating environment for the present invention;

FIG. 2 shows various domains that may be considered in describing the present invention;

FIG. 3 illustrates a simple unified modeling language use case for identifying potential components that may be needed in solving an exemplary business problem;

FIG. 4 identifies components and corresponding functions that may be implemented for the exemplary business process;

FIGS. 5A-5F provide specific implementation details for the email component included in FIG. 4;

FIG. 6 shows a portion of a unified modeling language activity diagram of the business process corresponding to the exemplary business problem;

FIG. 7 illustrates a network and component locations for a processing environment according to the present invention;

FIG. 8 shows various software objects that may be part of a node and corresponding interconnections in accordance with the present invention;

FIG. 9 is an exemplary flow chart according to one embodiment of the present invention; and

FIGS. 10A-10B show an exemplary method of accessing one or more software components according to the present invention.

### DETAILED DESCRIPTION OF THE INVENTION

The present invention extends to methods, systems, and computer program products for dynamically accessing software components in an environment that may include a plurality of processing nodes, where individual processing nodes include one or more software objects, such as one or more software component objects, a controller object, a database object, a trace object, an agent object, etc. Because a software component provides functionality that may be used to accomplish a particular goal or task, a software component may be referred to as a virtual processor for performing the functionality it implements. For often-requested functionality, multiple instances of a software component may be created to allow for load balancing.

Relationships between software components are defined by platform independent logic that is executed by the controller object. If the software components of a local node are not able to satisfy a particular request, an agent object may be contacted to determine if the request should be sent to a remote node for processing. Where no software components are available, a request may be scheduled for later execution. To minimize interdependencies that are preferably handled by the platform independent logic, individual software components may be completely independent and unaware of each other. Multiple requests for the same functionality by a single source may be processed by different software components to enhance load balancing. When needed, a software component may be reserved for future processing. The embodiments of the present invention may comprise a special purpose or general purpose computer including various computer hardware, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

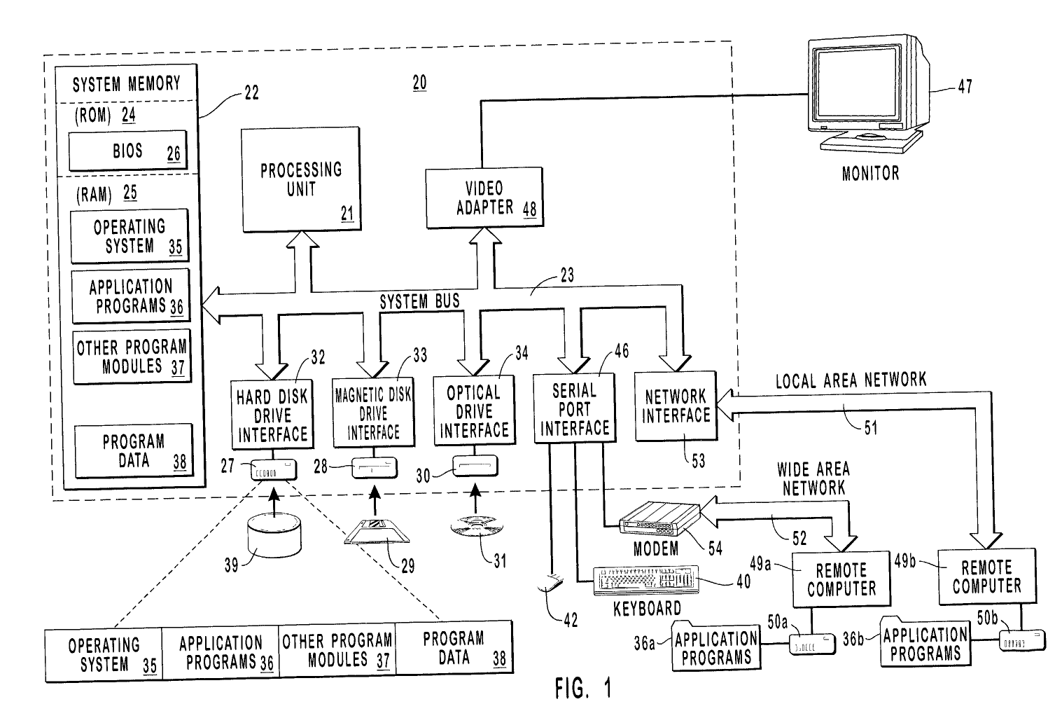

FIG. 1 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 1, an exemplary system for implementing the invention includes a general purpose computing device in the form of a conventional computer 20, including a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help transfer information between elements within the computer 20, such as during start-up, may be stored in ROM 24.

The computer 20 may also include a magnetic hard disk drive 27 for reading from and writing to a magnetic hard disk 39, a magnetic disk drive 28 for reading from or writing to a removable magnetic disk 29, and an optical disk drive 30 for reading from or writing to removable optical disk 31 such as a CD-ROM or other optical media. The magnetic hard disk drive 27, magnetic disk drive 28, and optical disk drive 30 are connected to the system bus 23 by a hard disk drive interface 32, a magnetic disk drive-interface 33, and an optical drive interface 34, respectively. The drives and their associated computer-readable media provide nonvolatile storage of computer-executable instructions, data structures, program modules and other data for the computer 20. Although the exemplary environment described herein employs a magnetic hard disk 39, a removable magnetic disk 29 and a removable optical disk 31, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk 39, magnetic disk 29, optical disk 31, ROM 24 or RAM 25, including an operating system 35, one or more application programs 36, other program modules 37, and program data 38. A user may enter commands and information into the computer 20 through keyboard 40, pointing device 42, or other input devices (not shown), such as a microphone, joy stick, game pad, satellite dish, scanner, or the like. These and other input devices are often connected to the processing unit 21 through a serial port interface 46 coupled to system bus 23. Alternatively, the input devices may be connected by other interfaces, such as a parallel port, a game port or a universal serial bus (USB). A monitor 47 or another display device is also connected to system bus 23 via an interface, such as video adapter 48. In addition to the monitor, personal computers typically include other peripheral output devices (not shown), such as speakers and printers.

The computer 20 may operate in a networked environment using logical connections to one or more remote computers, such as remote computers 49a and 49b. Remote computers 49a and 49b may each be another personal computer, a server, a router, a network PC, a peer device or other common network node, and typically include many or all of the elements described above relative to the computer 20, although only memory storage devices 50a and 50b and their associated application programs 36a and 36b have been illustrated in FIG. 1. The logical connections depicted in FIG. 1 include a local area network (LAN) 51 and a wide area network (WAN) 52 that are presented here by way of example and not limitation. Such networking environments are commonplace in office-wide or enterprise-wide computer networks, intranets and the Internet.

When used in a LAN networking environment, the computer 20 is connected to the local network 51 through a network interface or adapter 53. When used in a WAN networking environment, the computer 20 may include a modem 54, a wireless link, or other means for establishing communications over the wide area network 52, such as the Internet. The modem 54, which may be internal or external, is connected to the system bus 23 via the serial port interface 46. In a networked environment, program modules depicted relative to the computer 20, or portions thereof, may be stored in the remote memory storage device. It will be appreciated that the network connections shown are exemplary and other means of establishing communications over wide area network 52 may be used.

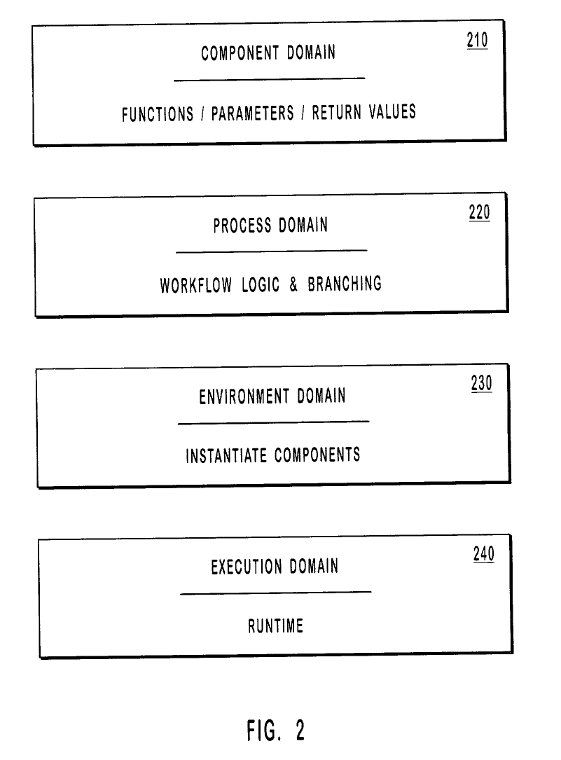

FIG. 2 shows various domains that may be considered in describing the present invention. Component domain 210 allows for the simplification of complex systems through abstraction. Individual components are defined in terms of the functionality provided, parameters or data that may be required, and return conditions. Components may be developed using any of various object-oriented methodologies in conjunction with standard technologies such as Common Object Request Broker Architecture (“CORBA”), Component Object Model/Distributed Component Object Model (“COM/DCOM”), Enterprise JavaBeans (“EJB”), etc. Each component is developed in isolation, without consideration of other components. Individual components may inherit functionality that is common to all components through an object-oriented class. The phases of inception and elaboration, coupled with requirements gathering, analysis, and design, map directly to the component domain. The component domain is mostly synchronous, accounting for tasks that are performed one at a time. Each component knows only of a single instance of itself, with one method per component instance being active at any given time.

In a distributed network, components of any platform may be mixed heterogeneously because the relationship between components is an infrastructure consideration addressed in the process domain 220. Unlike the component domain, process domain 220 is an asynchronous context in which to define processes. To define a process, functions are grouped in a logical order, based on desired workflow and branching conditions. The process domain 220 does not deal with the location of executing components (environment domain 230) or specific implementation issues (component domain 210). By separating implementation and operating environment, process domain 220 allows for business processes to be separated from target technology. As a result, solutions developed in process domain 220 remain valid, even when the underlying implementation is modified. The process domain 220 may be viewed in a variety of formats, including standard Unified Modeling Language (“UML”) activity diagrams, Tree Hierarchical, and Builder Linear.

The environment domain 230 includes network information and the specific location of each component. Functionality (the component domain 210) and process knowledge (the process domain 220) are not required in this domain. The environment is the aggregate arrangement of components on nodes in an enterprise network. Each node identifies the components that reside in memory as resources or services to the network. These runtime configurations are used to achieve the task or goal defined by an executing process. Dynamic scaling may be achieved through calculations based on the complete network configuration. For example, as nodes or hardware devices are added to a network, modifications are made to the configuration, making the new resource available for use. In contrast, scaling in traditional environments usually requires rewriting code to accommodate new resources.

Execution domain 240 guides execution from one procedure to the next as specified in the process domain and finds components on local and remote nodes to perform the requested functionality. Execution domain 240 also allows for recording every event that occurs in a network. Data and the movement of data throughout the network may be preserved for later review. Runtime monitoring is provided through several views, which log and format the event information, for flexible management options. Preserving event information allows for history monitoring, wherein an exact replica of a system may be simulated for troubleshooting many types of problems. Logged events and data also may be used to meet various reporting requirements.

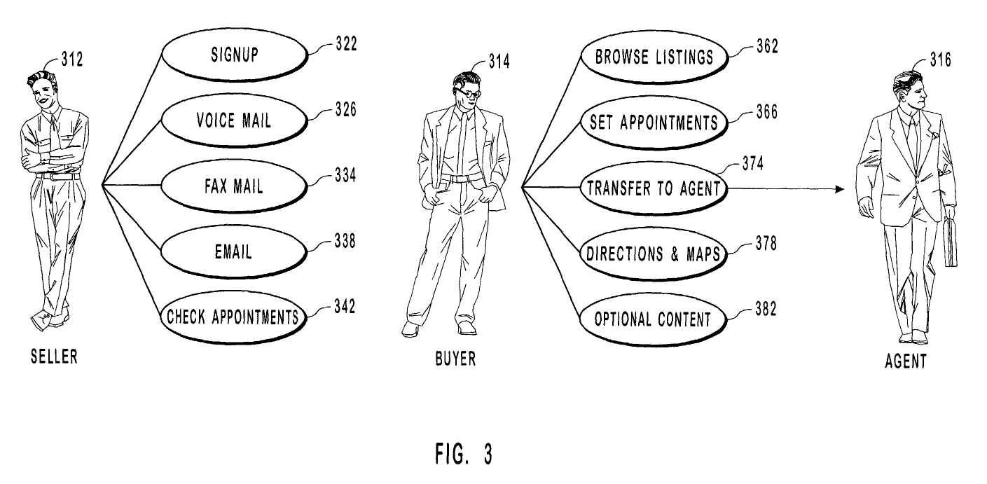

FIGS. 3-7 relate to an example of using the present invention in a practical business situation. Each of the domains is used to describe an application from requirements to execution. A generic development process illustrates how the present invention may be mapped into most organized development methodologies. In particular, the example considers a real estate company in a highly competitive market that whishes to expand its access to buyers and seller by providing telephone and Web access to an automated information center. In order to reach the largest market possible, the service should be easy to use, including as much human-like interaction as possible. Furthermore, free content services, such as news, sports, weather, and stock quotes, are provided to help lure potential buyers to browse the service. The company wishes to preserve its past investment in hardware including an HP 9000, a Solaris Web server, and a Linux email server. As shown in FIG. 3, the following requirements are gathered:

A seller 312 should be able to signup for listing 322 their property.

A seller 312 should be provided with individual electronic communication boxes capable of sending and receiving voicemail 326, faxmail 334, and email 338.

A seller 312 should be able to check the status of appointments 342 for requested showings.

A buyer 314 should be able to browse listing 362 by selecting filter options, or by ID numbers displayed on each property.

A buyer 314 should be able to set appointments 366 to walk through a home.

A buyer 314 should be transferred 374 to an agent 316 immediately if they so request.

A buyer 314 can obtain directions to properties 378 via voice or fax.

A buyer 314 optionally can hear specific content, such as weather, news, sports, stocks, and local movie times.

Buyers should be able to receive information on homes by voice or fax. Equal capabilities via a Web page should be provided as an alternative to the telephone. In defining components based on each use case, considering “what will perform a required action” and “what can be done one at a time” help to clarify the boundaries of individual components. For example, many of the use cases may require connectivity through a telephone line. Therefore, it is sensible to have a component called telephony that waits for a call on one line, answers it, hangs it up, records, plays, sends a fax, etc. Again, in the component domain, it is usually most helpful to consider what a component is capable of doing synchronously. A simple email component could be defined that would connect to a post office version 3 (“POP3”) or simple mail transfer protocol (“SMTP”) server, send email, get email, forward email, and reply to email.

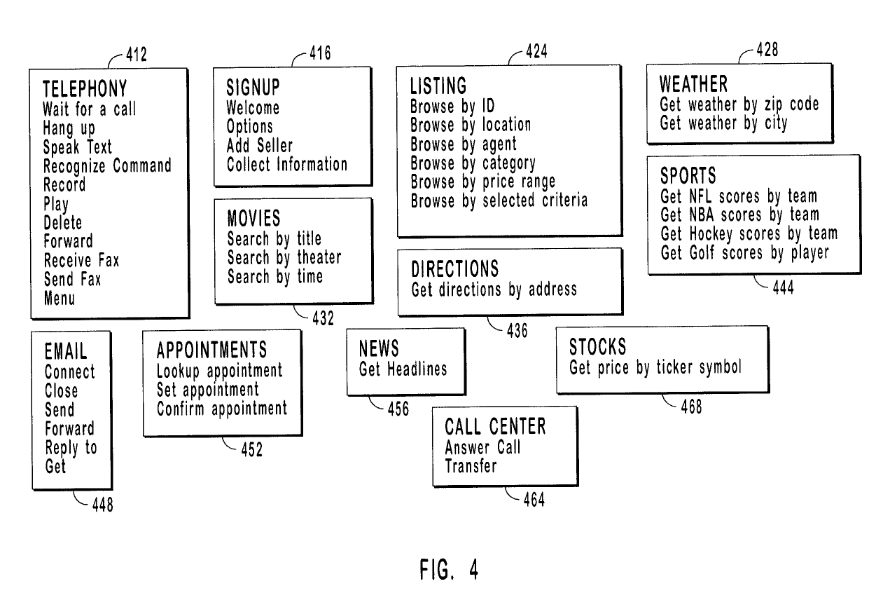

After iterative analysis, the components and corresponding functionality shown in FIG. 4 are defined. Telephony 412 includes functions that wait for a call, hang up, speak text, recognize a command, record, play, delete, forward, receive fax, send fax, and list menu options. Signup 416 provides a welcome, listing options, the ability to add a seller, and information collection. Listing 424 allows various browsing options, including browse by ID, browse by location, browse by agent, browse by category, browse by price range, and browse by selected criteria. Directions by address may be obtained through directions 436. Appointments 452 includes functions that lookup an appointment, set an appointment, and confirm a schedule. Email 448 defines functions that connect to an email server, close a connection, send an email, forward an email, replay to an email, and get email. Call center 464 provides for answering and transferring calls. The remaining components access other information. News 456 gets headlines, stocks 468 gets price by ticker symbol, weather 428 gets weather by zip code or city, and sports 444 gets NFL, NBA, or NHL scores by team, or golf scores by player.

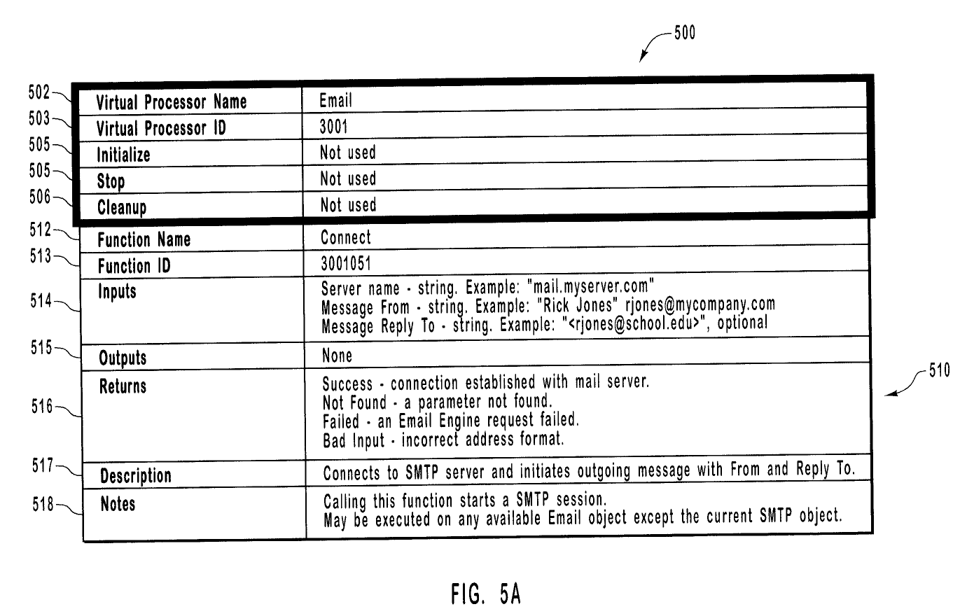

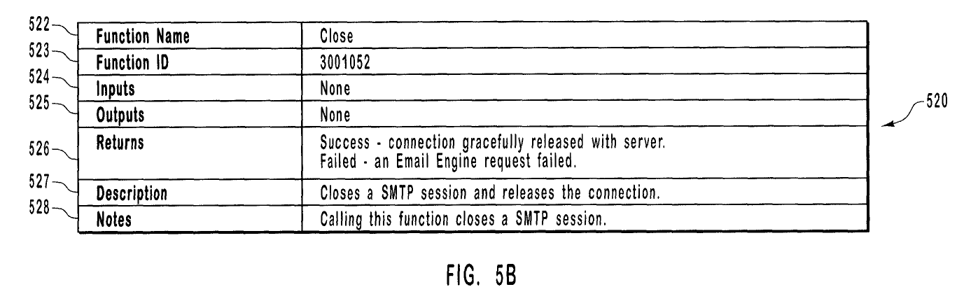

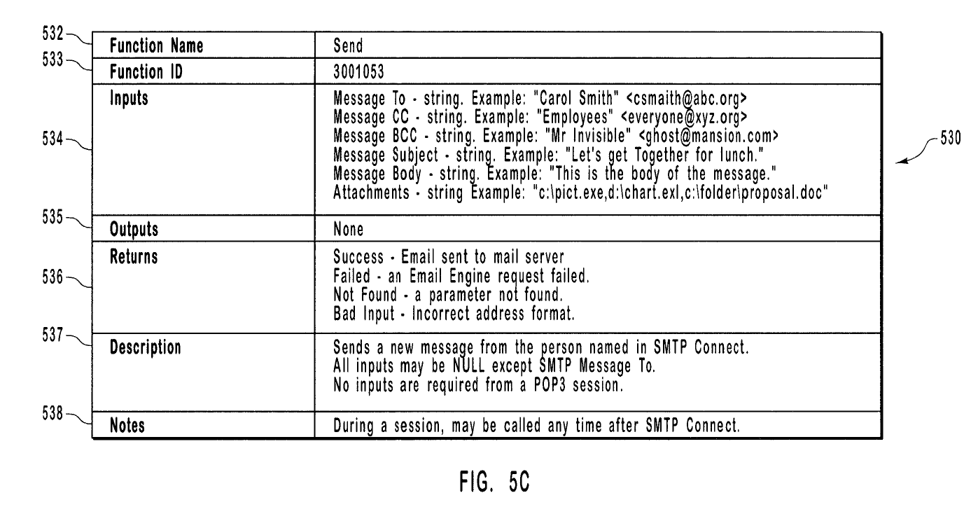

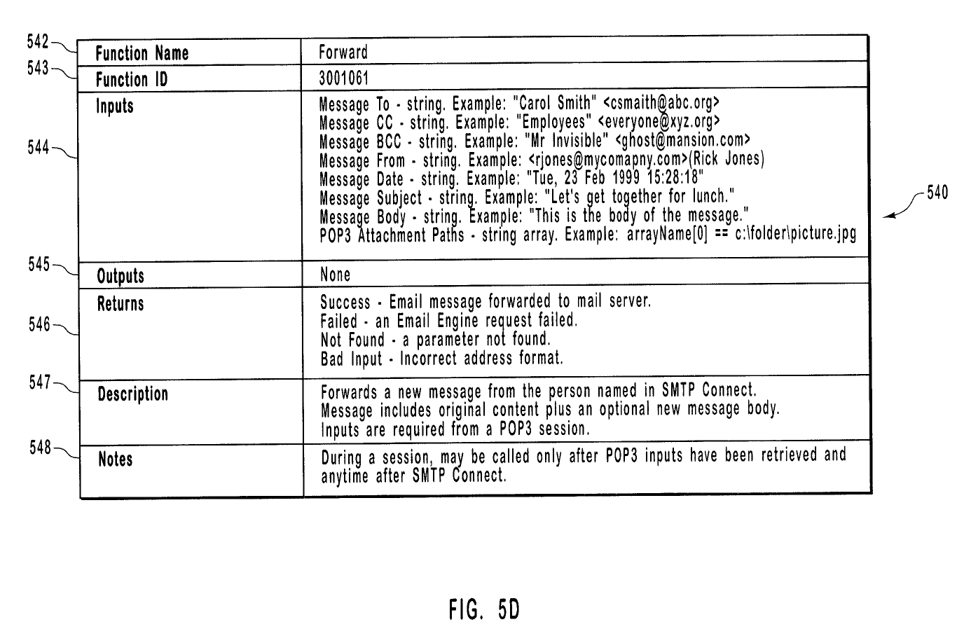

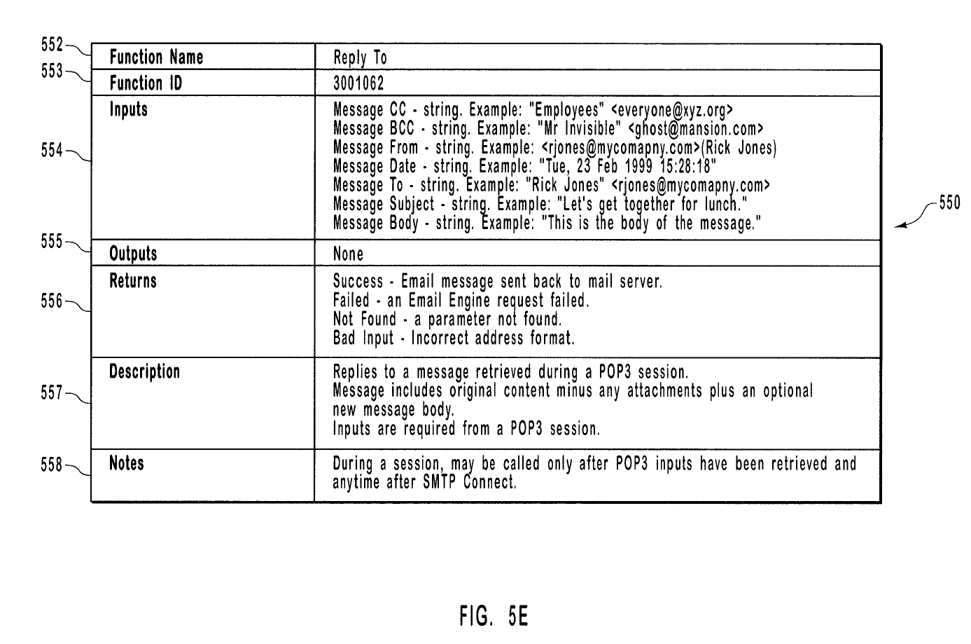

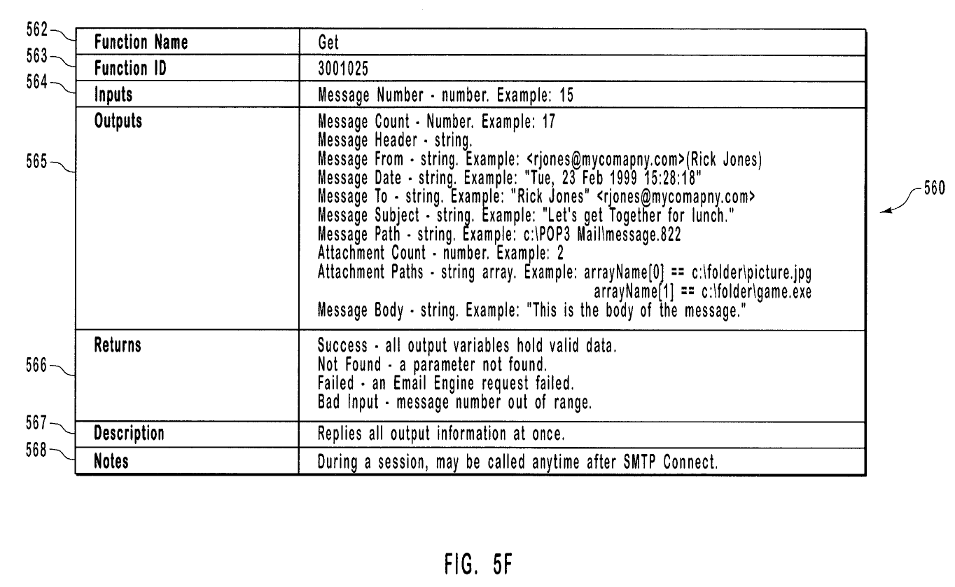

In order not to obscure the present invention, FIGS. 5A-5F provide specific implementation details only for email 448. In the component domain, components are defined in terms of functions, parameters, and return conditions. Relationships such as dependencies, associations, communication, synchronization, and other infrastructure related issues are not considered in the component domain. The interface shown in FIGS. 5A-5F exposes the information needed to interact with the functionality provided by email component 500.

The component or virtual processor name 502 is email and the virtual process ID 503 is 3001. Although not used in this particular example, initialize 504, stop 505, and cleanup 506 are routines that may be called to initialize the email component, stop the email component, and cleanup the email component on termination. The first function 510, has a name 512 of connect and an ID 513 of 3001051. Three parameters may be input 514, including a “server name” string, a “message from” string, and an optional “message reply to” string. No output parameters 515 are specified. The process domain uses returns 516 for workflow and branching. For example, a success return value allows for processing to continue, whereas not found, failed, and bad input may require some type of error handling. Description 517 describes what the function does and notes 518 provides information on how the function may be used.

As shown in FIGS. 5B-5F, the email component 500 also implements functions 520, 530, 540, 550, and 560, with (i) names close 522, send 532, forward 542, reply to 552, and get 562; (ii) function IDs 3001052 (523), 3001053 (533), 3001061 (543), 3001062 (553), and 3001025 (563); (iii) inputs 524, 534, 544, 554, and 564; (iv) outputs 525, 535, 545, 555, and 565; (v) returns 526, 536, 546, 556, and 566; (vi) descriptions 527, 537, 547, 557, and 567; (vii) and notes 528, 538, 548, 558, and 568.

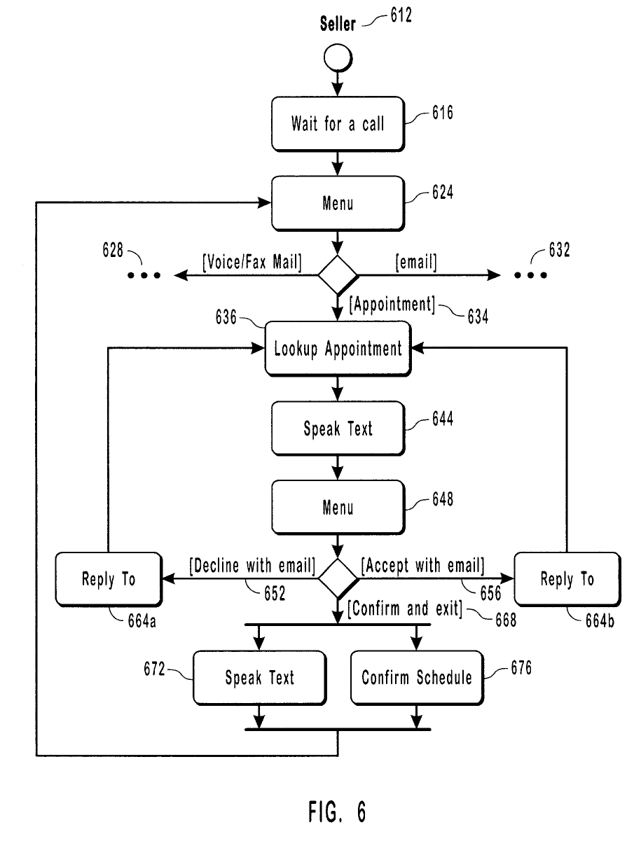

Work on the process domain, as shown in FIG. 6, may begin once the interfaces for the components are defined. The development of the components themselves may proceed in parallel with the workflow and branching logic that identifies the relationships and associations between individual components that occurs in the process domain. FIG. 6 shows a UML activity diagram for implementing the desired business process, but other suitable methodologies may be used as well. Using the functions provided by the components shown in FIG. 4, activities that take place are defined. For simplicity, FIG. 6 shows only enough of the Buyer's process to impart a sufficient understanding of the process domain. Unlike the component domain, the process domain involves asynchronous, rather than synchronous, events. One drawback to the activity diagram of FIG. 6 is that is does not explicitly show the movement of data. However, reference to the interface definitions for individual components, such as the exemplary email component of FIGS. 5A-5F, shows how data flows from one component to another.

Wait for a call 616 is a function of telephony component 412 (FIG. 4). Once a call is received, menu 624 provides seller 612 with a list of options. Seller 612 may choose voice/fax mail 628 options, email 632 options, or appointment 634 options. Selecting lookup appointment 636 selects the first appointment request and speak text 644 delivers an audio version. (The buyer may have submitted the appointment request over the Web.) Menu 648 lists the current options available to seller 612. Note that menu 624 and menu 648 are functions of telephone component 412, but are labeled separately to show that different options may be available at different points in the business process. In one embodiment, the menu component may take a list of options and present them to seller 612, allowing a specific option to be selected by entering a corresponding number or by speaking the option. Decline with email 652 calls reply to 664a and accept with email 656 calls reply to 664b to notify the buyer (or other party) of whether or not the seller is available at the time requested. In both cases, processing continues with lookup appointment 636 for the next appointment request. Confirm and exit 668 allows the seller to confirm schedule 676 by reviewing appointment requests that were accepted and then return to menu 624. Speak text 672 delivers an audio version of each appointment.

As indicated previously, the process domain allows for the complete separation and independence of components. In traditional component development, allowing one component to call another component often requires the calling component to include the interface definition of the component to be called. Although including an interface definition is preferable to duplicating the functionality of one software component in another, the end result is that components incorporating the interfaces of other components have associations with and relationships to each other. These associations and/or relationships lead to maintenance problems when changes in one component ripple through other components. In contrast, by defining relationships and associations in the process domain, components may be isolated from each other such that changes in one component need not affect any other component.

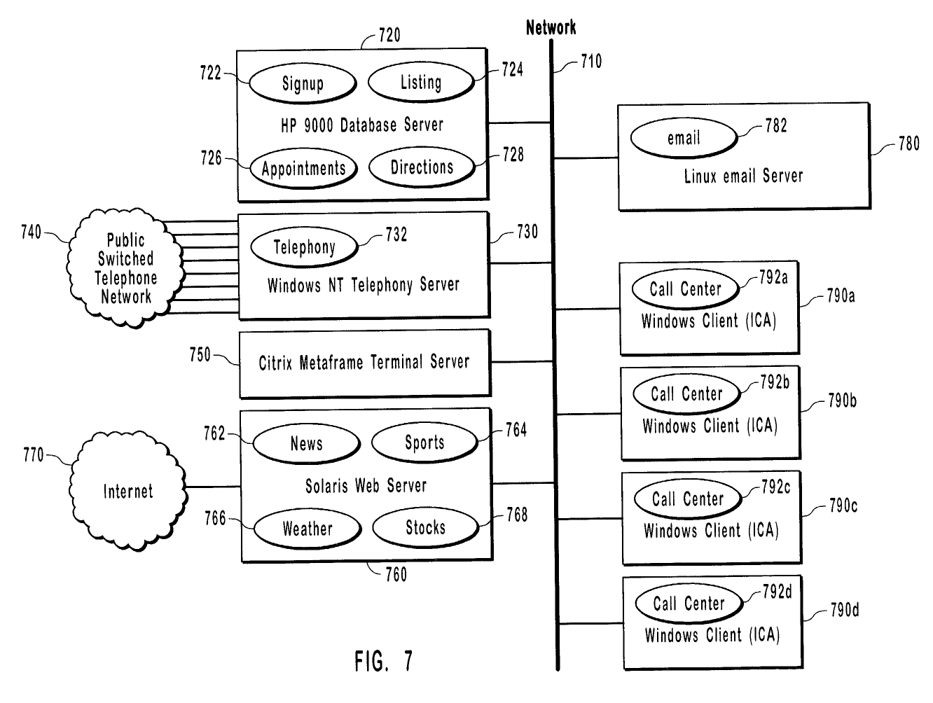

The environment domain, illustrated in FIG. 7, shows an exemplary network that operates according to the present invention. The environment domain is basically a description of the network 710 and the component locations. Note the integration of heterogeneous platforms and the distributed nature of the network. For example, the network includes HP 9000 database server 720, Windows NT telephony server 730, Citrix Metaframe terminal server 750, Solaris Web server 760, Linux email server 780, and Windows clients 790a, 790b, 790c, and 790d. Note that neither the component domain nor the process domain depended on the particular platform used to provide a resource to the network.

HP 9000 database server 720 includes signup component 722, listing component 724, appointments component 726, and directions component 728. Windows NT telephony server 730 is connected to public switched telephone network 740 and includes telephony component 732. Solaris Web server 760 in connected to Internet 770 and includes news component 762, sports component 764, weather component 766, and stocks component 768. Linux email server 780 includes email component 782. Windows clients 790a, 790b, 790c, and 790d include call center components 792a, 792b, 792c, and 792d.

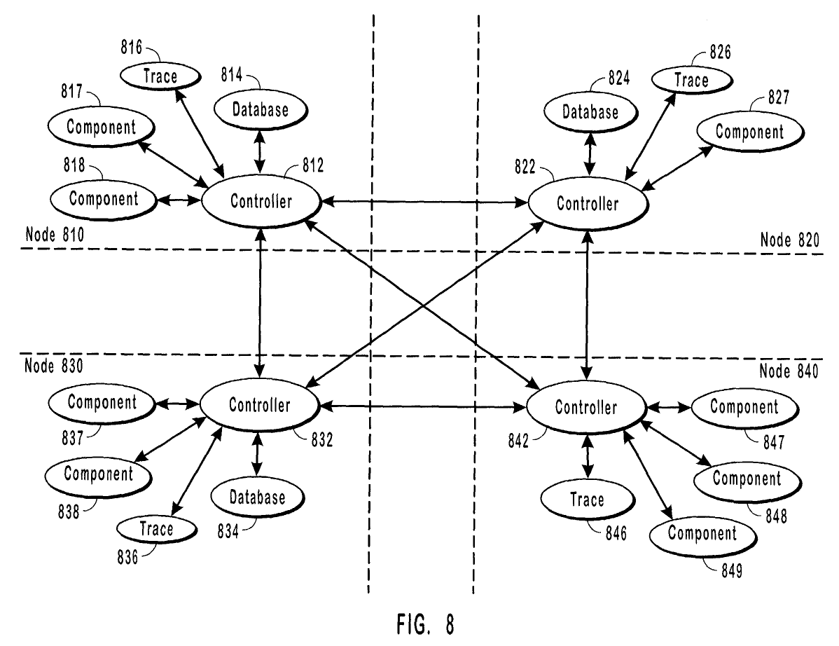

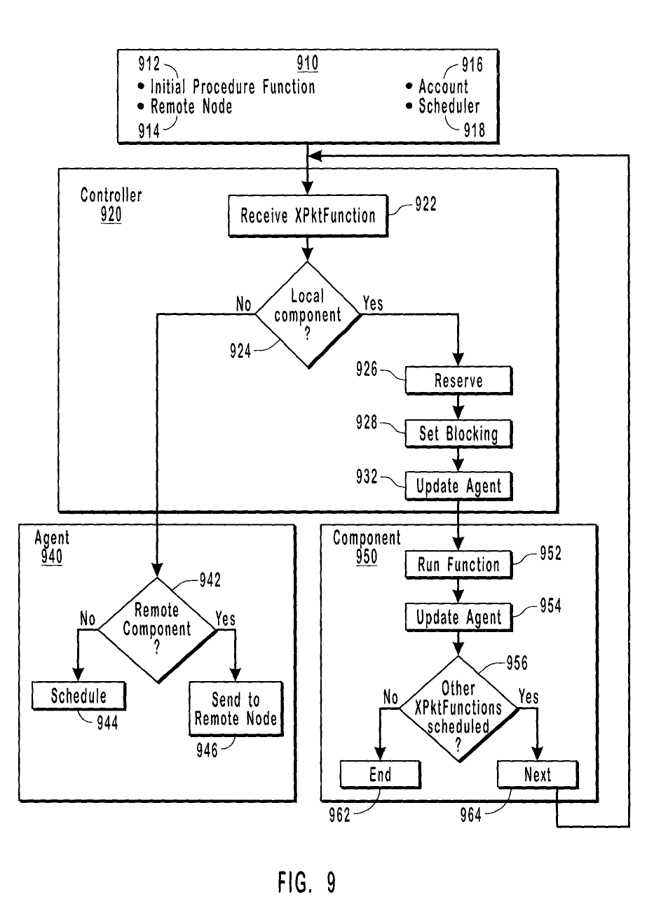

FIG. 8 shows various software objects that may be part of a processing node and corresponding interconnections in accordance with the present invention. FIG. 9 is an exemplary flow chart according to one embodiment of the present invention and is described below in conjunction with FIG. 8. References beginning with a “9” are found on FIG. 9 and references beginning with an “8” are found on FIG. 8. It should be noted that a processing node does not necessarily correspond to a single hardware node. A single hardware node may include multiple processing nodes and a single processing node may be distributed across multiple hardware nodes. Therefore, as used throughout this application, the terms “processing node” or simply “node” should be interpreted broadly to encompass virtually any hardware configuration.

Node 810 includes controller object 812, database object 814, trace object 816, and component objects 817 and 818. Node 820 includes controller object 822, database object 824, trace object 826, and component object 827. Node 830 includes controller object 832, database object 834, trace object 836, and component objects 837 and 838. Node 840 includes controller object 842, trace object 846, and component objects 847, 848, and 849. The various component objects at each node may be separate instances of the same software component for distributed processing and load balancing or may be completely different software components.

A controller object, such as controller 920 of FIG. 9, processes platform independent logic that defines workflow and branching conditions. As part of processing the platform independent logic, controller 920 receives XPktFunction 922. An XPktFunction 922 is a message that requests particular functionality and includes parameters and other data related to the requested functionality. XPktFunction 922 may originate from any of several sources 910, including an initial procedure function 912, a remote node 914, an account 916, and a scheduler 918. An account 916 is a collection of initial procedure functions and corresponding data. When an account is executed, all of its initial procedure functions are run. Accounts are executed to initialize an object, such as at startup or when a blocking function finishes with an object, or in response to an explicit call.

In decision block 924, controller 920 checks for a local component that is available to provide the requested functionality. The use of qualifiers such as “local” and “remote” is completely dependent on perspective. A local component is a component that exists at the node on which a particular controller is executing—all other components are remote. Likewise, a local component is remote to all other nodes. Therefore, the use of “local” and “remote” merely suggests the presence of multiple nodes and should not necessarily be interpreted as an indication of proximity.

If no local component is available, agent 940 is contacted. Agent 940 tracks the components and corresponding functionality that is available at each of several nodes. In decision block 942, agent 940 looks for a remote component that is available to provide the requested functionality. If a remote note is found, the request is sent to the remote node 946. Otherwise, the request is scheduled 944 for processing at a future time, when a suitable component is available.

Returning to decision block 924, if a local component is available, the controller 920 reserves 926 and sets blocking 928 as appropriate and updates the agent 932 responsible for tracking component availability at the particular node. The component 950 runs the function 952, updates the agent 954, and determines if other XPktFunctions are Scheduled 956 for the component. If not, component processing ends 962. Otherwise, the next XPktFunction is identified 964, and processing continues with controller 920 receiving another XPktFunction 922.

It should be pointed out that the present invention does not necessarily require that the same component be identified for more than a single request. In contrast, once traditional infrastructures identify a particular component, a connection may be established between the requester of functionality and the component such that subsequent requests are directed to the same component. Connections of this sort may circumvent efforts to load balance requests across several available resources, because after an initial component has been identified, no further evaluation of available resources takes place. The present invention allows a software component other than the one initially identified to satisfy subsequent requests.

Now referring back to FIG. 8, note that controller 812, controller 822, controller 832, and controller 842 are all interconnected. Although in the embodiment of FIG. 8 any controller may reach any other controller directly, it also is possible for one controller to reach another controller indirectly, through an intermediate controller. Trace objects 816, 826, 836, and 846 are used to monitor the operation of components on their respective nodes. The trace objects are capable of capturing events, data, and data movement for review, runtime monitoring, tracking transactions, and troubleshooting.

Note that each node in FIG. 8, with the exception of node 840, includes a database object. Database objects provide each node with platform independent data access. (This does not mean that the underlying storage mechanism is necessarily platform independent, but rather that access to the data is platform independent. In many circumstances it may be desirable to use commercial database vendors with platform specific data formats.) Access to the platform independent logic defined in the process domain and other data usually occur through a database object. However, in certain circumstances, a node, such as node 840, may not include a database object for any of a variety of reasons. The network for accessing a node or the node hardware itself may not support access to a particular database. Alternatively, design considerations may make it undesirable for a node to include a database object. Whatever the motivation, where a particular node does not support or include a database object, another node may be used to provide the node with data access. For example, one node with a database object may used to initialize another node without a database object. As used in this application, initializing another node should be interpreted broadly to encompass supplying a node with whatever data may be relevant for the operation of the node.

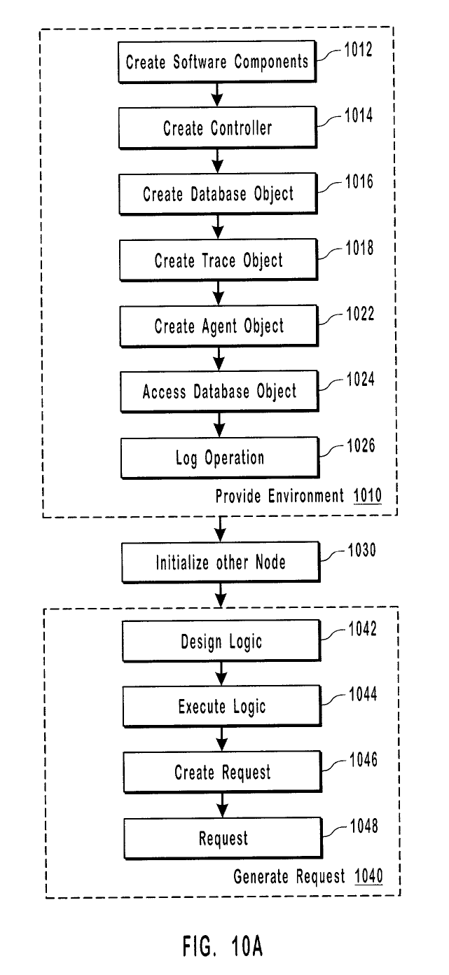

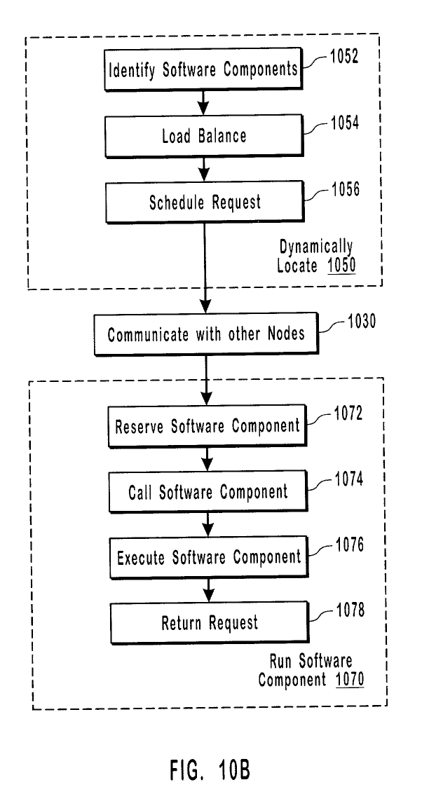

FIGS. 10A-10B show an exemplary method of accessing one or more software components according to the present invention. A step for providing (1010) an environment that includes at least one node may include the acts of: creating (1012) one or more software components; creating (1014) a controller object; creating (1016) a database object; creating (1018) a trace object; creating (1022) an agent object; accessing (1024) the database object for platform independent process logic, state information, or other platform independent data; and logging (1026) the operations of one or more software components. Where a particular node does not include a database object, the present invention may include the act of one node initialing (1030) another node.

A step for generating (1040) a request for the particular functionality offered by a software component may include the acts of: designing (1042) platform independent logic that defines a relationship between software components; executing (1044) the platform independent logic; creating (1046) a request for the particular functionality; and requesting (1048) the particular functionality.

A step for dynamically locating (1050) a software component may include the acts of: identifying (1052) a software component that is capable of satisfying the particular functionality of a request; load balancing (1054) multiple requests for the particular functionality across available software components; and scheduling (1056) a request for particular functionality until a software component becomes available. Where multiple nodes are available, the present invention also may include the act of communicating (1060) with other nodes.

A step for running (1070) a software component may include the acts of: reserving (1072) a software component prior to requesting the functionality of the software component; calling (1074) the software component; executing (1076) the software component; and returning (1078) a result or status from the software component. Those of skill in the art will recognize that the present invention does not necessarily depend on any particular ordering of the foregoing steps and acts, and will further recognize that some steps and/or acts may be omitted or have other steps and/or acts substituted, yet fall without the scope of the present invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by United States Letters Patent is:

1. In a computerized system with a plurality of software objects, including one or more software component objects, each comprising one or more functions, wherein an interface for accessing the one or more software component objects and corresponding one or more functions is based on parameters and return values, a method of dynamically accessing the one or more software component objects in accomplishing a task or goal, wherein the method comprises acts of:
creating at least one node, wherein the at least one node includes (i) one or more software component objects each comprising one or more functions implementing a particular functionality, and (ii) a controller object that manages interaction with the one or more software component objects;
requesting the particular functionality of at least one of the one or more functions of the one or more software component objects;
dynamically identifying a first software component object that is capable of satisfying the request for the particular functionality, wherein the identification of the first software component object may persist only for the request, independent of any particular requester, allowing another software component object to be dynamically identified for a subsequent request, even where the subsequent request is from a prior requester; and
calling the first software component object.

2. A method as recited in claim 1, wherein multiple software component objects are capable of satisfying the request for the particular functionality, the method further comprising acts of:
subsequently requesting the particular functionality;
dynamically identifying a second software component object that is capable of satisfying the request for the particular functionality; and
calling the second software component object.

3. A method as recited in claim 1, wherein the at least one node includes a plurality of software component objects, and wherein the plurality of software component objects themselves are completely independent and unaware of each other.

4. A method as recited in claim 3, further comprising an act of designing platform independent logic that defines a relationship between at least two of the plurality of software component objects, the logic including at least one of processing flow and one or more branching conditions.

5. A method as recited in claim 1, wherein multiple software component objects are capable of satisfying the request for the particular functionality, the method further comprising an act of load balancing multiple requests for the particular functionality across the multiple software component objects.

6. A method as recited in claim 1, wherein the at least one node further comprises a database object that provides access to at least one of (i) platform independent logic, (ii) state information for one or more software component objects, and (iii) platform independent data, the method further comprising an act of accessing either the platform independent logic, the state information, or the platform independent data through the database object.

7. A method as recited in claim 6, wherein the database object of the at least one node accesses platform independent logic, the method further comprising the controller performing acts of:
executing the platform independent logic; and
creating a request for the particular functionality.

8. A method as recited in claim 1, wherein the at least one node further comprises a trace object capable of tracking the processing that occurs in the at least one node, the method further comprising an act of logging an operation of at least one function of the first software component object.

9. A method as recited in claim 1, wherein the at least one node includes multiple nodes.

10. A method as recited in claim 9, wherein at least two of the multiple nodes are remote from each other, one of the at least two multiple nodes being a local node and the other being a remote node.

11. A method as recited in claim 10, wherein one or more nodes include an agent object that tracks which software component objects are available at each of several nodes for which the agent is responsible, and wherein a given node is unable to identify a local software component object that is capable of satisfying the request for the particular functionality, and wherein the agent dynamically identifies the first software component.

12. A method as recited in claim 9, wherein the multiple nodes are located on a single hardware node.

13. A method as recited in claim 9, further comprising an act of the multiple nodes communicating with each other through platform independent messages.

14. A method as recited in claim 13, wherein a message includes at least one of (i) a parameter, (ii) a return value, (iii) an instruction, and (iv) other data.

15. A method as recited in claim 9, further comprising an act of one or more nodes initializing one or more other nodes.

16. A method as recited in claim 1, wherein the at least one node is distributed across multiple hardware nodes.

17. A method as recited in claim 1, wherein no software component object is available initially, the method further comprising an act of scheduling the request of the particular functionality until the first software component object becomes available.

18. A method as recited in claim 1, wherein the first software component object is identified prior to requesting the particular functionality, the method further comprising an act of reserving the first software component object.

19. A method as recited in claim 1, further comprising acts of:
executing the first software component to perform the requested functionality; and
returning a result.

20. In a computerized system with a plurality of software objects, including one or more software component objects, each comprising one or more functions, wherein an interface for accessing the one or more software component objects and corresponding one or more functions is based on parameters and return values, a method of dynamically accessing the one or more software component objects in accomplishing a task or goal, wherein the method comprises acts of:
creating a plurality of nodes, wherein each node includes (i) one or more software component objects each comprising one or more functions implementing a particular functionality, wherein each of the software component objects is independent and unaware of any other software component object, and (ii) a controller object that manages interaction with the one or more software component objects;
requesting the particular functionality of at least one of the one or more functions of the one or more software component objects;
dynamically identifying a first software component object that is capable of satisfying the request for the particular functionality, wherein the identification of the first software component object may persist only for the request, independent of any particular requester, allowing another software component object to be dynamically identified for a subsequent request, even where the subsequent request is from a prior requester; and
calling the first software component object.

21. A method as recited in claim 20, wherein multiple software component objects are capable of satisfying the request for the particular functionality, the method further comprising an act of load balancing multiple requests for the particular functionality across the multiple software component objects.

22. A method as recited in claim 20, wherein at least one node further comprises a database object that provides access to at least one of (i) platform independent logic that defines a relationship between at least two software components, the logic including at least one of processing flow and one or more branching conditions, (ii) state information for one or more software component objects, and (iii) platform independent data, the method further comprising an act of accessing either the platform independent logic, the state information, or the platform independent data through the database object.

23. A method as recited in claim 22, wherein the database object of the at least one node accesses platform independent logic, the method further comprising the controller performing acts of:
executing the platform independent logic; and
creating a request for the particular functionality.

24. A method as recited in claim 20, wherein at least one node further comprises a trace object capable of tracking the processing that occurs in the at least one node, the method further comprising an act of logging an operation of at least one function of the first software component object.

25. A method as recited in claim 20, wherein at least two of the plurality of nodes are remote from each other, one of the at least two nodes being a local node and the other being a remote node, and wherein at least one node includes an agent object that tracks which software component objects are available at each of several nodes for which the agent is responsible, wherein a given node is unable to identify a local software component object that is capable of satisfying the request for the particular functionality, and wherein the agent dynamically identifies the first software component.

26. A method as recited in claim 20, further comprising an act of at least two of the plurality of nodes communicating with each other through platform independent messages.

27. A method as recited in claim 20, further comprising an act of one or more nodes initializing at one or more other nodes.

28. A method as recited in claim 20, wherein no software component object is available initially, the method further comprising an act of scheduling the request of the particular functionality until the first software component object becomes available.

29. A method as recited in claim 20, wherein the first software component object is identified prior to requesting the particular functionality, the method further comprising an act of reserving the first software component object.

30. In a computerized system with a plurality of software objects, including one or more software component objects, each comprising one or more functions, wherein an interface for accessing the one or more software component objects and corresponding one or more functions is based on parameters and return values, a method of dynamically accessing the one or more software component objects in accomplishing a task or goal, wherein the method comprises steps for:
providing an environment that includes at least one node, wherein the at least one node includes (i) one or more software component objects each comprising one or more functions implementing a particular functionality, and (ii) a controller object that manages interaction with the one or more software component objects;
generating a request for the particular functionality of at least one of the one or more functions of the one or more software component objects;
dynamically locating a first software component object that is capable of satisfying the request for the particular functionality, wherein the dynamically locating permits another software component object to be dynamically located for a subsequent request, even where the subsequent request is from a prior requester; and
running the first software component object.

31. A method as recited in claim 30, wherein multiple software component objects are capable of satisfying the request for the particular functionality, the method further comprising steps for:
generating a subsequent request for the particular functionality;
dynamically locating a second software component object that is capable of satisfying the request for the particular functionality; and
running the second software component object.

32. A method as recited in claim 30, wherein multiple software component objects are capable of satisfying the request for the particular functionality, and wherein the step for dynamically locating comprises acts of:
identifying the first software component; and
load balancing multiple requests for the particular functionality across the multiple software component objects.

33. A method as recited in claim 30, wherein no software component object is available initially, and wherein the step for dynamically locating comprises an act of scheduling the request of the particular functionality until the first software component object becomes available.

34. A method as recited in claim 30, wherein the first software component object is located prior to generating a request for the particular functionality, and wherein the step for running the first software component object comprises acts of:
reserving the first software component object;
calling the first software component object;
executing the first software component object to perform the requested functionality; and
returning a result.

35. A method as recited in claim 30, wherein the environment includes a plurality of software component objects, and wherein the plurality of software component objects themselves are completely independent and unaware of each other, and wherein the step for generating a request comprises acts of:
designing platform independent logic that defines a relationship between at least two of the plurality of software component objects, the logic including at least one of processing flow and one or more branching conditions;
executing the platform independent logic;
creating a request for the particular functionality; and
requesting the particular functionality.

36. A method as recited in claim 30, wherein the step for providing an environment that includes at least one node comprises acts of:
creating the one or more software component objects for the at least one node; and
creating the controller object for the at least one node.

37. A method as recited in claim 36, wherein the environment includes multiple nodes, and wherein at least two of the multiple nodes are remote from each other, one of the at least two multiple nodes being a local node and the other being a remote node.

38. A method as recited in claim 37, wherein the step for providing an environment further comprises an act of creating an agent object for one or more nodes, the agent object tracking which software component objects are available at each of several nodes for which the agent is responsible, wherein a given node is unable to identify a local software component object that is capable of satisfying the request for the particular functionality, and wherein the agent dynamically identifies the first software component.

39. A method as recited in claim 37, wherein the step for providing an environment further comprises an act of one or more nodes initializing one or more other nodes.

40. A method as recited in claim 37, further comprising the act of the multiple nodes communicating with each other through platform independent messages.

41. A method as recited in claim 36, wherein the step for providing an environment further comprises acts of:
creating a database object for the at least one node, the database object providing access to at least one of (i) platform independent logic, (ii) state information for the one or more software component objects; and (iii) platform independent data;
accessing either the platform independent logic, the state information, or the platform independent data through the database object;
creating a trace object that is capable of tracking the processing that occurs in the at least one node; and
logging an operation of at least one function of the first software component object.

42. In a computerized system that allows for a plurality of software objects and may include one or more software component objects, each with one or more functions, and may include a controller object that manages interaction with the one or more software component objects, a method of dynamically accessing the one or more software component objects comprising acts of:
defining an interface for at least two software component objects, the interface specifying (i) each function of the one or more software objects, (ii) any parameters relevant to each function, and (iii) any return values relevant to each function;
defining one or more relationships between the at least two software components, wherein the relationships or associations are separate and independent from any implementation of the at least two software component objects, and wherein the relationships or associations are stored as platform independent logic to be processed by a controller object; and
defining an environment that specifies the location of the at least two software component objects, wherein the at least two software component objects may be distributed across one or more processing nodes.

43. A method as recited in claim 42, further comprising the act of dynamically identifying a first software component object that is capable of satisfying a request for particular functionality, wherein another software component may be dynamically identified for a subsequent request for the particular functionality.

44. A method as recited in claim 42, wherein the one or more processing nodes comprises at least one of (i) an agent object that tracks which software components are available at each of several nodes for which the agent is responsible, wherein the agent dynamically identifies a first software component, (ii) a database object that provides access to at least one of platform independent logic, state information, and platform independent data, and (iii) a trace object capable of tracking the processing that occurs in at least one processing node.

45. A method as recited in claim 42, wherein multiple software component objects are capable of satisfying a request for particular functionality, the method further comprising the act of load balancing multiple requests for the particular functionality across the multiple software components.

46. A method as recited in claim 42, the method further comprising at least one of the acts of (i) scheduling a request for particular functionality until a software component object capable of satisfying the request becomes available, and (ii) reserving a software component object prior to requesting particular functionality of the software component object.

47. A computer program product for implementing, in a computerized system with a plurality of software objects, including one or more software component objects, each comprising one or more functions, wherein an interface for accessing the one or more software component objects and corresponding one or more functions is based on parameters and return values, a method of dynamically accessing the one or more software component objects in accomplishing a task or goal, wherein the computer program product comprises:
a computer readable medium for carrying machine-executable instructions for implementing the method, wherein the method comprises the acts of:
creating at least one node, wherein the at least one node includes (i) one or more software component objects each comprising one or more functions implementing a particular functionality, and (ii) a controller object that manages interaction with the one or more software component objects;
requesting the particular functionality of at least one of the one or more functions of the one or more software component objects;
dynamically identifying a first software component object that is capable of satisfying the request for the particular functionality, wherein the identification of the first software component object may persist only for the request, independent of any particular requester, allowing another software component object to be dynamically identified for a subsequent request, even where the subsequent request is from a prior requester; and
calling the first software component object.

48. A computer program product as recited in claim 47, wherein multiple software component objects are capable of satisfying the request for the particular functionality, the method further comprising acts of:
subsequently requesting the particular functionality;
dynamically identifying a second software component object that is capable of satisfying the request for the particular functionality; and
calling the second software component object.

49. A computer program product as recited in claim 47, wherein the at least one node includes a plurality of software component objects, and wherein the plurality of software component objects themselves are completely independent and unaware of each other, the method further comprising an act of designing platform independent logic that defines a relationship between at least two of the plurality of software component objects, the logic including at least one of processing flow and one or more branching conditions.

50. A computer program product as recited in claim 47, wherein multiple software component objects are capable of satisfying the request for the particular functionality, the method further comprising an act of load balancing multiple requests for the particular functionality across the multiple software component objects.

51. A computer program product as recited in claim 47, wherein the at least one node further comprises a database object that provides access to at least one of (i) platform independent logic, (ii) state information for one or more software component objects, and (iii) platform independent data, the method further comprising an act of accessing either the platform independent logic, the state information, or the platform independent data through the database object.

52. A computer program product as recited in claim 51, wherein the database object of the at least one node accesses platform independent logic, the method further comprising acts of:
executing the platform independent logic; and
creating a request for the particular functionality.

53. A computer program product as recited in claim 47, wherein the at least one node further comprises a trace object capable of tracking the processing that occurs in the at least one node, the method further comprising an act of logging an operation of at least one function of the first software component object.

54. A computer program product as recited in claim 47, wherein the at least one node includes multiple nodes.

55. A computer program product as recited in claim 54, wherein at least two of the multiple nodes are remote from each other, one of the at least two nodes being a local node and the other being a remote node, and wherein one or more nodes include an agent object that tracks which software component objects are available at each of several nodes for which the agent is responsible, wherein a given node is unable to identify a local software component object that is capable of satisfying the request for the particular functionality, and wherein the agent dynamically identifies the first software component.

56. A computer program product as recited in claim 54, wherein the multiple nodes are located on a single hardware node.

57. A computer program product as recited in claim 54, the method further comprising an act of the multiple nodes communicating with each other through platform independent messages.

58. A computer program product as recited in claim 54, the method further comprising an act of one or more nodes initializing one or more other nodes.

59. A computer program product as recited in claim 47, wherein the at least one node is distributed across multiple hardware nodes.

60. A computer program product as recited in claim 47, wherein no software component object is available initially, the method further comprising an act of scheduling the request of the particular functionality until the first software component object becomes available.

61. A computer program product as recited in claim 47, wherein the first software component object is identified prior to requesting the particular functionality, the method further comprising an act of reserving the first software component object.

62. A computer program product as recited in claim 47, the method further comprising acts of:
executing the first software component to perform the requested functionality; and
returning a result.
